(19) United States
(12) Patent Application Publication
(10) Pub. No.: US 2004/0073890 A1
(43) Pub. Date: Apr. 15, 2004

(54) Method and system for test management

(76) Inventors: Raul Johnson, Austin, TX (US); Roger Borchers, Austin, TX (US); Nikiforos E. Stamatakis, Austin, TX (US)

Correspondence Address: HAMILTON & TERRILE, LLP, P.O. BOX 203518, AUSTIN, TX, 78720, US

(21) Appl. No.: 10/267,513

(22) Filed: Oct. 9, 2002

(51) Int. Cl. G06F 9/44

(52) U.S. Cl. 717/124; 717/101; 717/120

(57) ABSTRACT

Product testing management separates test cases from configurations to simplify test case and configuration re-use. For instance, information handling system test management with a test case versus configuration matrix view simplifies re-use of test cases and configurations. A three-dimensional view supports iterative development of systems based on different development stages by tracking version changes to test cases and configurations across projects, groups and test plans with an effective visualization. Improved communication among projects and groups is provided with centralized storage of common test cases and configurations that maintain project or group integrity by allowing access to test data with modification rights limited to selected testing participants.

### BACKGROUND OF THE INVENTION

1. Field of the Invention

The present invention relates in general to the field of system testing, and more particularly to a method and system for test management of test cases, system configurations, and test results, such as test management of information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The wide variety of available information handling system configurations presents difficulty to information handling system manufacturers, which generally must test configurations to validate their operation before the configurations are sold to customers. For instance, the inclusion of a component manufactured by a new supplier is typically tested for proper operation with other components, including software, to ensure the compatibility of the components in an operational system. Although various information handling system components are designed and built to comply with standards that aid proper operation, only actual validation of operation of a given configuration ensures proper interaction of components. However, physical testing of actual systems presents a substantial logistical problem. For instance, a large number of configurations have to be built and tested with consistent testing procedures to identify failures and potential problems. Since actual testing of all possible configurations is impractical, priorities for testing procedures and configurations are generally established with a goal of reducing the problems that crop up in commercially sold systems. Once problems are identified in testing and corrected, additional testing is generally performed to validate configurations that were corrected.

In an attempt to obtain accurate test results for various configurations, test engineers typically develop test cases with defined procedures that are performed on information handling systems to determine if selected configurations pass or fail. By re-using test cases on different configurations, test engineers are able to make meaningful comparisons across different configurations for pass and failure rates. However, with the wide variety of software and hardware components that may be used to define a configuration, the testing and recording of test results to allow meaningful comparisons is difficult to achieve. For instance, different projects for validation of a given set of configurations and different groups for validation of a given set of components are likely to perform and record test procedures in an inconsistent manner. Another difficulty is that test cases evolve over time to address changes in configurations as well as shifting priorities for testing. Further, test cases are often designed for specific configurations and stored to include configuration information. Thus, test engineers that test information handling systems or other systems with a wide variety of configurations of ten are limited in their ability to apply historical testing information in development of effective test procedures that meet production priorities.

### SUMMARY OF THE INVENTION

Therefore a need has arisen for a method and system which separates configurations from the test cases on which the configurations are run to simplify reuse of test cases with a test case versus configuration matrix view.

A further need exists for a method and system which provides iterative test development for tracking test case and configuration versions and associated results through different development stages and across projects and groups.

In accordance with the present invention, a method and system are provided which substantially reduce the disadvantages and problems associated with previous methods and systems for testing products. Test iterations are defined as a matrix of test cells, each test cell having an associated test case to run on a system configuration to validate the system. Test cases are defined separately from configurations for simplified re-use and development of new versions with results stored for test case procedures in the test cells of the matrix. Versions of test cases and configurations are identified and tracked with stacked matrices that give an effective visualization of test case and configuration coverage and aid in metric generation, such as test case and configuration use and pass rates across various test groups, projects, plans and versions.

More specifically, a test case engine creates new and modified test cases with each test case having procedures for validating information handling system functionality. A configuration engine creates new and modified information handling system configurations with each configuration having selected components, such as hardware and software components. A test iteration engine aligns a test case or set of test cases with a configuration to present a matrix view of one or more test cells that guide testing of an information handling system having the identified configuration. Test results are recorded in the test cells as tests are run for simplified access and analysis. In one embodiment, a three-dimensional view of stacked matrices presents an effective visualization of different versions of test cases and configurations to aid in analysis of test results and design of future test procedures. Multiple group and project management with improved communication is supported by centralized access to test results with restricted modification permissions. Thus, a group testing of a project for validation of an information handling system configuration or component may access and use test information from other groups or projects to create new versions of test cases and configurations without modifying the other group or projects data. In this way, both groups and products are able to leverage test results from the other to more effectively use limited testing resources.

The present invention provides a number of important technical advantages. One example of an important technical advantage is that test cases are developed and stored separate from configurations. Separation of test cases and configurations simplifies reuse of multiple test cases or sets of test cases by presenting a matrix view of test cases versus configurations. Conceptual isolation of test case development improves traceability of testing by tracking usage and pass/fail rates for test cases across projects, groups and test plans. Test case metrics improves test plan development by providing test engineers with an overall view the effectiveness of a test case at identifying problems. With products having a complex variation of configurations, such as information handling systems, central storage of test results for different projects and groups improves test plan development to focus on desired objectives by accessibility to a greater store of test data and lessons learned in an organized format.

Another example of an important technical advantage of the present invention is that iterative test development is simplified for tracking test case and configuration versions and associated results through different development stages and across projects and groups. Iterative development allows the organization of test results based on different product development stages, for instance by presenting test case and configuration versions in three-dimensional stacked matrices with related versions of test cases and configurations presented with an effective visualization. Thus, unrelated groups or projects may use existing test cases and configurations as a starting point for validation of an information handling system to effectively gain from the experience of past testing without interfering with other projects or groups development of test engineering management.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a test management system adapted to manage testing of information handling systems with reusable test cases and configurations;

FIG. 2 depicts a flow diagram for defining, using and modifying test cases and configurations in test iterations with separation between test case and configuration development and application;

FIG. 3 depicts a block diagram of a searchable test case library to identify test cases based on various factors, such as product type, operating system, author or other desired factors; and

FIG. 4 depicts test iterations presented as stack matrices that simplify visualization and tracing of test case and configuration versions.

### DETAILED DESCRIPTION

Management of the testing of products presents a complex task, especially where the products are continually changing and evolving. Information handling systems are an example of such continuously changing products. Information handling system component configurations change as software and hardware improve in functionality and speed, either with newly developed components or new versions of existing components. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

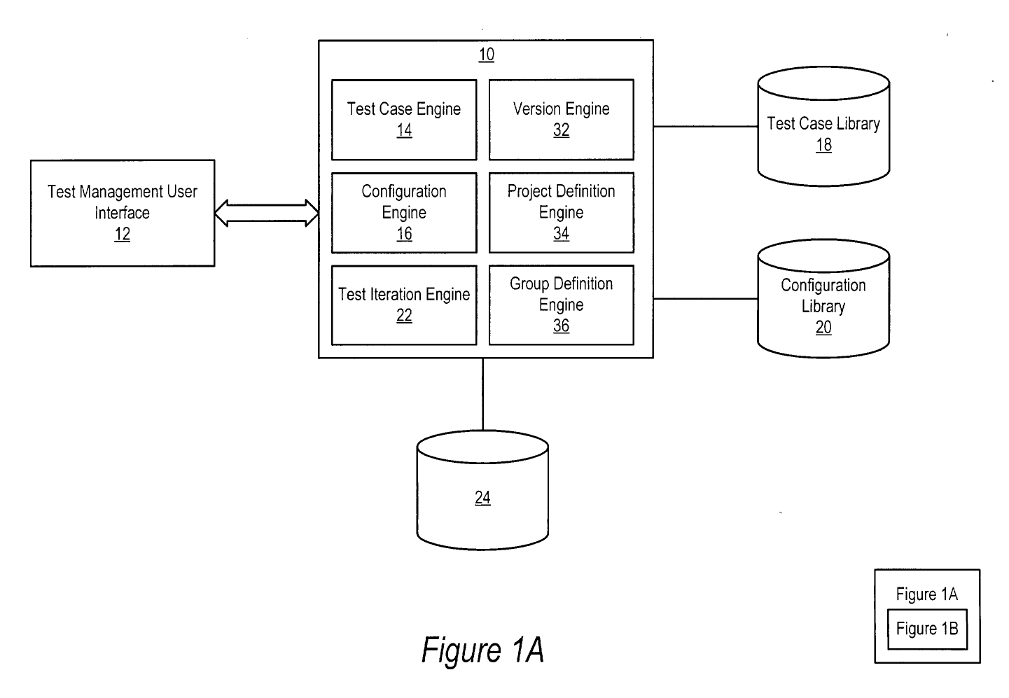

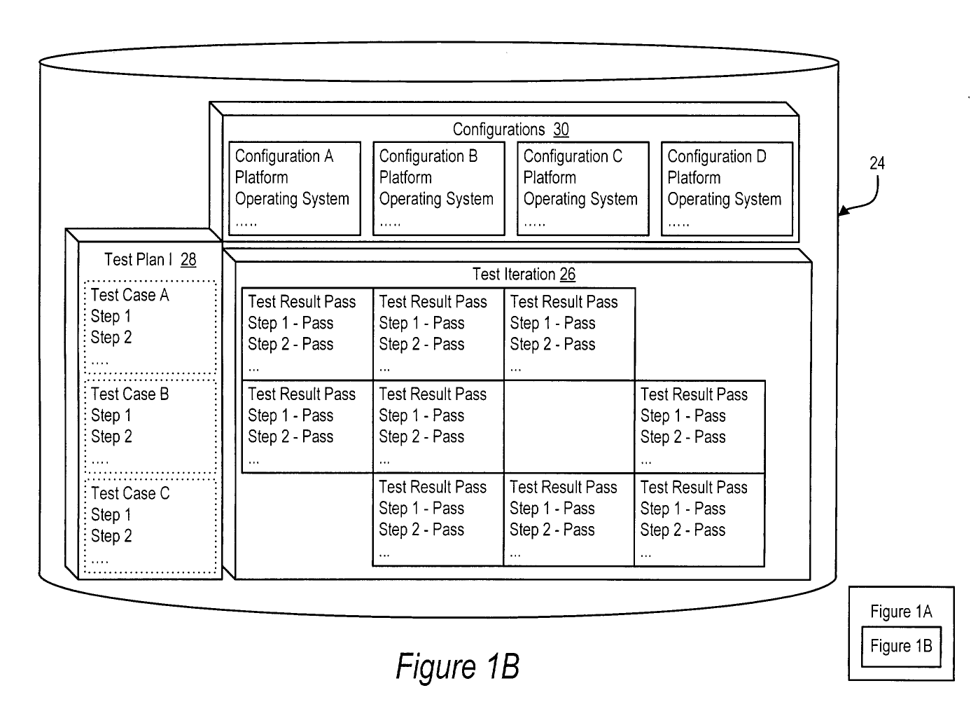

The present invention provides product test management by separating configurations from the test cases they are run on, thus simplifying test case and configuration reuse through a central test management location. Referring now to FIG. 1, a block diagram depicts a test management system 10 adapted to manage testing of information handling systems with reusable test cases and configurations. A test management user interface 12 interfaces with a test case engine 14 and configuration engine 16 to define test cases with procedures to validate information handling system functionality and configurations for information handling systems that are designated for testing. For instance, test case procedures include numbered steps to follow, description of actions to take at each step, and the expected result of step. A test case library 18 stores test cases defined by test case engine 14 and a configuration library 20 stores configurations defined by configuration engine 16. A test iteration engine 22 organizes test iterations by associating a test case or set of test cases with a configuration for the test case to run on and storing results in test cells 26 arranged by test matrix 24. For a given test cell 26, a test case from a test plan column 28 and a configuration from a configuration row 30 are identified by the position of the test cell 26 in the test matrix 24.

Separation of management of test cases from configurations allows for separate reuse of test cases and configurations with a matrix view that gives an effective visualization of test case versus configuration coverage. Test management system 10 coordinates reuse and tracking of test cases and configurations with a version engine 32, a project definition engine 34 and a group definition engine 36. Version engine 32 creates versioned test cases and configurations that are reusable and traceable across multiple groups, projects and test plans. For instance, defined projects or groups that develop and test different types information handling systems may access and use common test cases and configurations from libraries 18 and 20. Version engine 32 allows each project or group to adopt test cases or configurations by saving alterations as new versions that are tracked by a version list. Conceptual isolation of test cases, configurations and iterations tracked separately and by versions, aids in multi-group development within the same project space while managing testing independently. Metric generation for test case and configuration use is nonetheless expanded by tracking test case and configuration use across different versions and independent of project and group definitions. For instance, the number of tests and results for tests performed under a predetermined test case or configuration is traceable to view how many times the test case or configuration was used, passed or failed across all or selected groups, projects, versions and test plans. However, permission to alter testing information is based on project or group approval.

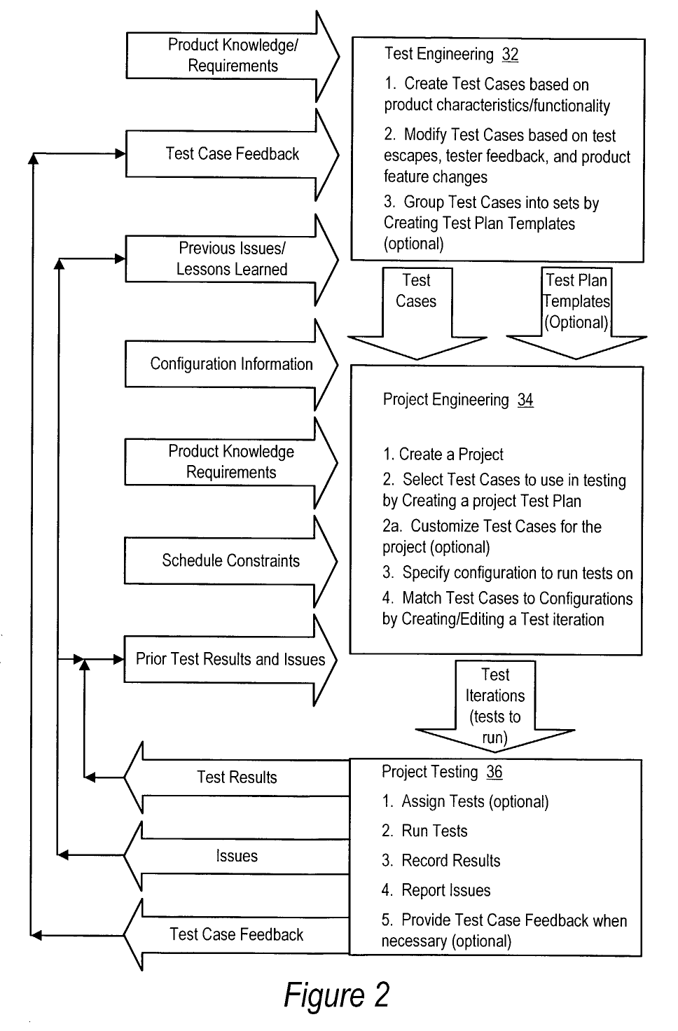

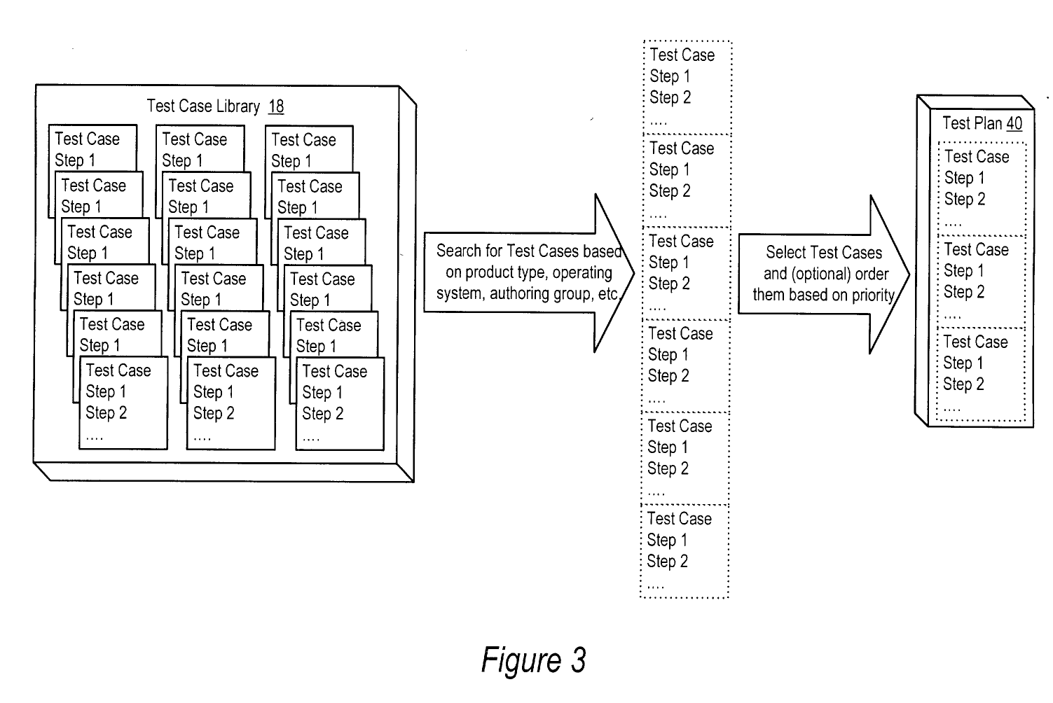

Referring now to FIG. 2, a flow diagram depicts a process for defining, using and modifying test cases and configurations in test iterations that allow separation between test case and configuration development and application. The process starts at step 32 with test engineering to create test cases based on the characteristics and functionality of the system under test, such as from an evaluation of product knowledge requirements for the system. For instance, an information handling system test case to validate modem operation may include procedures for a series of boots of the operating system to recognize and load drivers for the modem followed by dialing attempts to predetermined phone numbers for data exchange. The test cases are then modified based on test case feedback from tests performed with the test case and based on previous issues that have arisen or lessons learned from other tests or product developments. For instance, tracing the use of previous versions of the test case provides information on results from selected projects or groups. In addition, test cases may be organized into test plans that include a set of test cases applicable to a predetermined project or configuration. As depicted by FIG. 3, test case library 18 is searchable to identify test cases based on various factors, such as product type, operating system, author or other desired factors. Selected test cases from the search results are organized as a test plan 40 that represents a sequence of test cases to be run on a system under test.

At step 34, project engineering creates a project, such as for testing an information handling system product, based on configuration information, product knowledge requirements and schedule restraints for the system under test. Test cases and test plans are selected and customized to validate operation of the information handling system. In addition, prior test results and issues for selected test cases are considered in the formulation of the project plan. Once the project plan with the desired test cases are selected, configurations for the information handling system are specified and matched with test cases to define a test iteration of one or more test cells 26. For instance, an information handling system that includes a component with a defined specification may have a first configuration in which the component is manufactured by a first manufacturer and a second configuration in which the component is manufactured by a second manufacturer. The test cells define the procedures performed and store the results for each procedure.

At step 36, test iterations are run on the information handling system based on the test cases associated with the configuration of the information handling system. The matrix view provides a user interface that supports the assignment of test cases to test technicians and supports the inputting of test results by the technicians as well as inclusion of specific comments for the test procedures. As tests are run and results recorded, reports are issued to test engineering for tracking test progress and adapting tests with feedback. For instance, a technician assigned to test a selected configuration of an information handling system obtains and follows test procedures from the matrix view for the configuration and inputs results for each test procedure. After repetitions of the test cases, test engineers may view results to update test cases where testing failures are encouraged by test case faults instead of configuration faults. Such an analysis may include test case results across various configurations, groups, projects and versions to better focus testing procedures to achieve desired objectives.

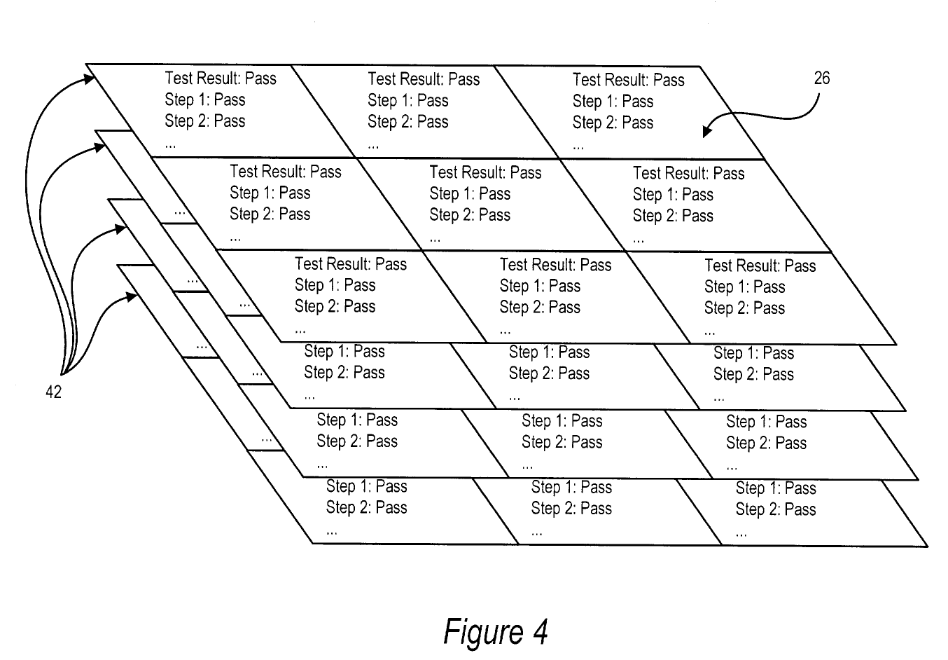

Referring now to FIG. 4, one embodiment of a three-dimensional visualization of test cases versus configurations is depicted. Test iteration stacks 42 illustrate the tracking of test case and configuration versions with an effective visualization that aids in the re-use and analysis of test results. Each stacked matrix arranges different versions of the same test case or configuration to align with related versions so that a single view of a user interface depicts an ordered development of test cases and configurations. For instance, a search through test results for selected criterion allows test engineers to locate relevant test information for review. Test cases or configurations are sorted by any number of criterion, such as source of development, results, number of attempts, configuration components, projects, groups, test plans, etc . . . The test cases and configuration are then presented through a user interface as three-dimensional stacked matrices that aid test engineers in analysis of historical test results. Historical analysis of test results helps to focus test activity to accomplish product testing objects in an efficient manner.

Although the present invention has been described in detail, it should be understood that various changes, substitutions and alterations can be made hereto without departing from the spirit and scope of the invention as defined by the appended claims.

What is claimed is:

1. A system for information handling system test management, the system comprising:
a test case engine operable to generate information handling system test cases, each test case having procedures for verification of one or more information handling system functions;
a configuration engine operable to generate information handling system configurations subject to test; and
a test iteration engine operable to define a matrix of test cells, each test cell having a test case and a configuration to validate.

2. The system of claim 1 wherein the test case engine is further operable to define test plans having plural test cases.

3. The system of claim 1 wherein each test cell further has a results entry that stores test procedure results for the test case procedures of the test case performed on the configuration associated with the test cell.

4. The system of claim 1 further comprising a version engine interfaced with the test case engine and the configuration engine, the version engine operable to create updated versions of test cases and configurations and to track test case and configuration version relationships.

5. The system of claim 4 wherein the iteration engine is further operable to stack test cell matrices by test case versions.

6. The system of claim 4 wherein the iteration engine is further operable to stack test cell matrices by configuration versions.

7. The system of claim 4 wherein the test iteration engine further comprises a test case list and a configuration list operable to associate test case and configuration versions to stacked test cell results.

8. A method for managing testing of a system, the method comprising:
generating system test cases, each test case having procedures for verification of one or more system functions;
generating system configurations subject to test, each configuration having plural components identified by function; and
defining a matrix of test cells, each test cell having a test case and a configuration to validate.

9. The method of claim 8 further comprising defining test plans, each test plan having plural test cases.

10. The method of claim 8 further comprising:
performing test iterations by selecting one or more test cells and running the test case on the configuration associated with each selected test cell; and
storing in the test cell the results of the procedures of the test case.

11. The method of claim 8 further comprising:
generating one or more test case versions; and
stacking test cells by test case versions.

12. The method of claim 8 further comprising:
generating one or more configuration versions; and
stacking test cells by configuration versions.

13. The method of claim 8 wherein the system under test comprises an information handling system.

14. The method of claim 13 wherein a configuration component comprises an information handling system operating system.

15. The method of claim 13 wherein a test case comprises procedures for operating an information handling system to validate proper operation of system components.

16. The method of claim 12 further comprising tracing test results for a predetermined test case and plural versions of a predetermined configuration.

17. The method of claim 13 further comprising tracing test results for a predetermined configuration and plural versions of a predetermined test case.

18. A computer readable medium having data comprising:
a plurality of test cases, each test case having procedures for validating an information handling system;
a plurality of configurations, each configuration defining information handling system components; and
a matrix of plural test cells, each test cell associated with a test case and a configuration to define a test iteration.

19. The computer readable medium of claim 18 further comprising plural versions of one or more test cases arranged as stacked matrices of plural test cells.

20. The computer readable medium of claim 18 further comprising plural versions of one or more configurations arranged as stacked matrices of plural test cells.
